(19) United States
(12) Patent Application Publication
(10) Pub. No.: US 2013/0264087 A1
(43) Pub. Date: Oct. 10, 2013

(54) Driving Tool

(71) Applicants: Tetsuhiro Harada, Hitachinaka (JP); Nobuhiro Takano, Hitachinaka (JP); Tomomasa Nishikawa, Hitachinaka (JP); Hironori Mashiko, Hitachinaka (JP)

(72) Inventors: Tetsuhiro Harada, Hitachinaka (JP); Nobuhiro Takano, Hitachinaka (JP); Tomomasa Nishikawa, Hitachinaka (JP); Hironori Mashiko, Hitachinaka (JP)

(73) Assignee: Hitachi Koki Co., Ltd., Tokyo (JP)

(21) Appl. No.: 13/882,012

(22) PCT Filed: Dec. 28, 2011
(86) PCT No.: PCT/JP2011/080594

§ 371 Date: Apr. 26, 2013

(30) Foreign Application Priority Data
Dec. 28, 2010 (JP) 2010-293676
Mar. 14, 2011 (JP) 2011-055136

(51) Int. Cl. B23B 45/00

(52) U.S. Cl. CPC B23B 45/00
USPC 173/213

(57) ABSTRACT

A driving tool includes a motor, and an end-bit holding section. The motor includes an output shaft. The end-bit holding section is connected to and rotated by the motor and configured to hold an end-bit. The driving tool further includes a weight connected to the motor without a reduction mechanism and rotatable together with the motor and the end-bit holding section.

### TECHNICAL FIELD

The invention relates to a driving tool, and more particularly to a driving tool for driving a screw, a bolt, and the like, with an end bit.

### BACKGROUND ART

Conventionally, a driving tool is known which is a so-called impact tool for driving screws such as a nut, a bolt, and the like. A known impact tool is configured to transmit striking force to an output shaft in a rotational direction with rotational impact force of a hammer. The impact tool of this configuration includes a motor, a hammer, and an anvil.

In the impact tool, the motor disposed within a housing is driven by using electric power supplied from a rechargeable battery or electric power supplied from outside through a power cord, and a spindle is rotated by the motor via a reduction mechanism. The hammer rotatable on the spindle and movable in the axial direction strikes the anvil via a steel ball inserted in a cam groove formed in the spindle, thereby performing a driving operation.

The hammer is urged forward by a spring disposed between the reduction mechanism and the spindle. When rotational resistance increases after a screw is seated at a workpiece, rotation of the anvil is suppressed, and the hammer gets over a hammer impact section of the anvil and is accelerated to strike the anvil again. In this way, rotational striking force is transmitted to an end bit (not shown) such as a hexagonal socket and the like several times or a dozen times continuously or intermittently, thereby performing driving operations of a nut or a bolt. Such a driving tool is described in Japanese Patent Application Publications No. 2005-022082 and No. 2010-058186, for example.

However, in a driving tool of this configuration, the hammer and the anvil are generally made of metal material. Thus, although striking is performed effectively, noises at impacts are so large that it is difficult to use the driving tool under an environment where low noises are required.

Accordingly, as a low-noise driving tool, an oil-pulse tool is known that includes an oil-pulse mechanism for transmitting rotation of a motor. The oil-pulse unit of the oil-pulse tool is configured by two sections of a driving section that rotates in synchronization with the motor, and an output section that rotates in synchronization with an output shaft to which an end bit is attached. Each time the driving section rotates once, oil pressure rises sharply at a position of sealing oil that is provided at one position for the one rotation, and an impact pulse is generated to transmit output-shaft driving torque. With this arrangement, rotational striking force is transmitted to an end bit (not shown) such as a hexagonal socket and the like several times or a dozen times continuously or intermittently, thereby performing driving operations of a nut or a bolt. This type of driving tool is described in Japanese Patent Application Publication No. 2003-039341, for example.

### DISCLOSURE OF INVENTION

### Solution to Problem

The oil-pulse tool described in Japanese Patent Application Publication No. 2003-039341 generates lower noises than the impact tool described in Japanese Patent Application Publications No. 2005-022082. However, because driving of a bolt or the like is generally performed by striking several times or a dozen times, noises stand out at a quiet place. Further, when parts are assembled in a factory, fitting of parts are sometimes confirmed by listening to a sound. However, if the oil-pulse tool is used in such a factory, noises of the oil-pulse tool sometimes hinder the confirming operation. Accordingly, there is a need for a tool that generates lower noises than the oil-pulse tool does.

Here, lowering (reducing) of noises includes both lowering a level of noise that is generated at one strike and reducing the number of times of strikes so as to reduce the number of times noises are generated.

In order to reduce the number of times of strikes, for example, screw driving can be performed with one strike by using a configuration where a motor and an end bit are connected via a reduction mechanism. However, with this configuration, driving torque becomes less than one tenth of driving torque of an impact tool using a comparable motor. Additionally, reaction transmitted to an operator's hand becomes very large, which is dangerous. A common cordless oil-pulse tool is better in safety than the impact tool, but reaction transmitted to a hand during driving a bolt is still large, which lays a burden on the operator during continuous operations.

In view of the foregoing, it is an object of the invention to provide a driving tool that generates extremely small striking noise, that can drive a bolt or a screw in one strike, and that generates small reaction.

In order to attain the above and other objects, the invention provides a driving tool includes a motor, and an end-bit holding section. The motor includes an output shaft. The end-bit holding section is connected to and rotated by the motor and configured to hold an end-bit. The driving tool further includes a weight connected to the motor without a reduction mechanism and rotatable together with the motor and the end-bit holding section.

Preferably, the driving tool further includes at least one of a first control unit and a second control unit. The first control unit controls the motor to rotate at constant rotational speed. The second control unit stops or reduces supply of electric current to the motor when a value of the electric current flowing through the motor is greater than or equal to a prescribed value.

Preferably, the motor and the weight are configured to transmit to the end-bit holding section a rotational energy per driving torque of 1 Nm in a range from 0.2 J to 0.4 J.

Preferably, the weight provides a moment of inertia in a range from 80 kg·m² to 150 kg·m². The motor is rotatable at a rotational speed in a range from 350 rad/s to 500 rad/s. The motor and the weight transmits the rotational energy to the end-bit holding section in a range from 8 J to 16 J.

Preferably, the weight is directly fixed to the motor.

Preferably the weight includes a plurality of weight segments.

Preferably, the driving tool further includes a rotational start delaying unit through which the weight is connected to the end-bit holding section to rotate the weight together with the end-bit holding section after the weight rotates a prescribed angle from start of rotation.

The invention also provides a driving tool includes a motor and an end-bit holding section. The driving tool further includes a weight configured to accumulate rotational energy by being rotated by the motor. The weight is connected to an end-bit through the end-bit holding section. The weight transmits a rotational energy after at least part of the weight rotates by equal to or greater than 360 degrees.

Preferably, the weight is directly fixed to the motor and is directly fixed to the end-bit holding section after at least part of the weight rotates by equal to or greater than 360 degrees.

Preferably, the driving tool further includes at least one of a first control unit and a second control unit. The first control unit controls the motor to rotate at constant rotational speed. The second control unit stops or reduces supply of electric current to the motor when a value of the electric current flowing through the motor is greater than or equal to a prescribed value.

Preferably, the weight includes a plurality of weights coaxially rotatable about a rotational axis. The plurality of weights includes a first weight located at a first position on the rotational axis and a second weight located at a second position on the rotational axis and different from the first position. The first weight is configured to be connected to the end-bit holding section, and the second weight is rotated by the motor. One weight of the plurality of weights contacts another weight of the plurality of weights that is adjacent to the one weight after the one weight rotates by approximately 360 degrees.

Preferably, the driving tool further includes a control unit and a switch. When the control unit receives a signal from the switch in a state where the motor is stopped, the control unit controls the motor to rotate such that the one weight contacts another weight after the one weight rotates approximately 360 degrees.

Preferably, the driving tool further includes a control unit including at least one of a first reversing unit and a second reversing unit. The first reversing unit controls the motor to rotate the second weight approximately in a first direction and subsequently to rotate the second weight in a second direction opposite to the first direction. After the motor rotates in the second direction, the second reversing unit controls the motor to rotate the second weight approximately 360 degrees in the first direction and subsequently stops the motor.

Preferably, the driving tool further includes a control unit and a reversing switch reversing rotational direction of the motor, thereby designating the rotational direction of the motor. After the control unit receives a signal instructing to reverse the rotational direction of the motor, the control unit controls the motor to rotate the second weight by approximately 360 degrees relative to a weight of the plurality of weights adjacent to the second weight in a direction opposite to the direction designated by the reversing switch.

Preferably, the end-bit holding section rotates about a rotational axis and includes a holding-section-side contact part. The driving tool further includes a supporting section rotatably supporting the end-bit section and slidably supporting the end-bit in a direction parallel to the rotational axis of the end-bit. The weight rotates coaxially with the end-bit holding section and includes a weight-side contact part. Only when the end-bit holding section slides toward the weight, the holding-section-side contact part contacts the weight-side contact parts and the end-bit supporting section rotates coaxially with the weight.

### Advantageous Effects

As described above, the invention can provide a driving tool that generates extremely small striking noise, that can drive a bolt or a screw in one strike, and that generates small reaction.

### BRIEF DESCRIPTION OF DRAWINGS

In the drawings:

FIG. 1A is a cross section of a driving tool according to a first embodiment;

FIG. 1B is a block diagram illustrating switches according to a first embodiment;

FIG. 2 is a front view of an output shaft of a motor according to the first embodiment;

FIG. 3 is graphs showing a relation between an electric current flowing through the motor, torque, and rotational speed according to the first embodiment;

FIG. 4 is graphs showing a relation between moment of inertia and rotational speed of a weight of the driving tool according to the first embodiment;

FIG. 5 is a flowchart illustrating operations and controls of a control circuit of the driving root according to the first embodiment;

FIG. 6 is a cross section of a driving tool according to a second embodiment;

FIG. 7 is a side view of a weight according to a second embodiment;

FIG. 8 is a cross section of the weight taken along a VIII-VIII line shown in FIG. 7;

FIG. 9 is a cross section of the weight taken along a IX-IX line shown in FIG. 7;

FIG. 10 is a cross section of the weight in a state where the weight cannot accumulate rotational energy;

FIG. 11 is a cross section of the weight in a state where the weight can accumulate the rotational energy;

FIG. 12 is a flowchart illustrating operations and controls of a control circuit of the driving root according to the second embodiment;

FIG. 13 is graphs showing are relation between moment of inertia and rotational speed of a weight of the driving tool according to the second embodiment;

FIG. 14 is a cross section of a driving tool according to a third embodiment;

FIG. 15 is a cross section of the weight taken along a XV-XV line shown in FIG. 14;

FIG. 16 is a cross section of a driving tool according to a fourth embodiment.

### REFERENCE SIGNS LIST

1, 101, 201, 301 driving tool
30, 130, 230, 330 motor
40, 140, 240, 340 weight
15, 115, 215, 315 control circuit
41, 154, 354 sleeve
150, 240A, 350 anvil

### BEST MODE FOR CARRYING OUT THE INVENTION

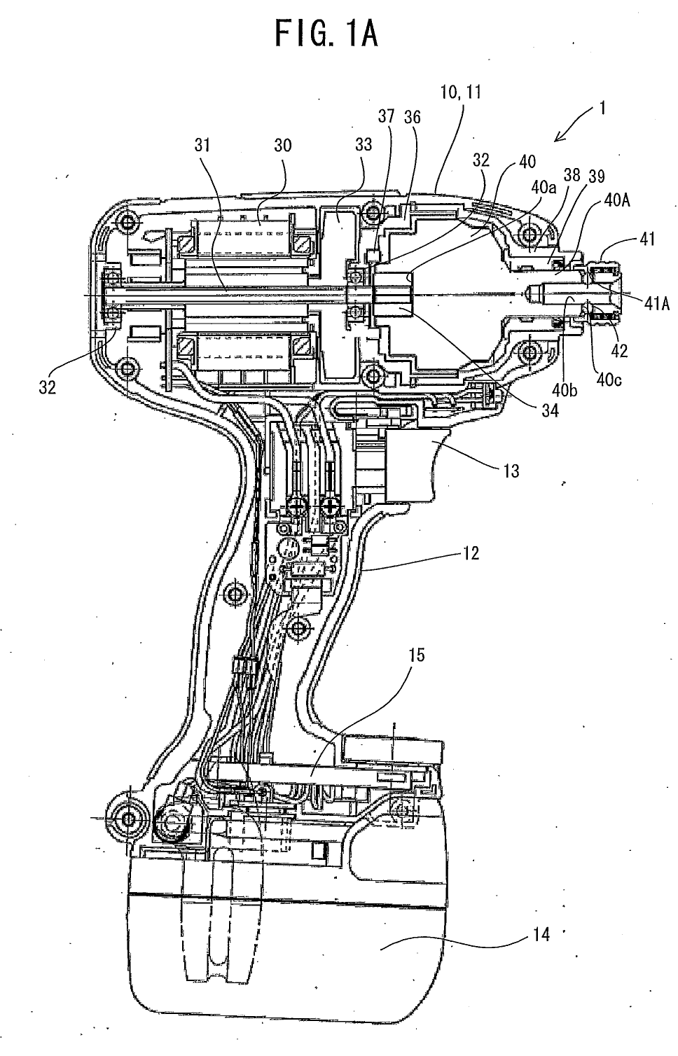

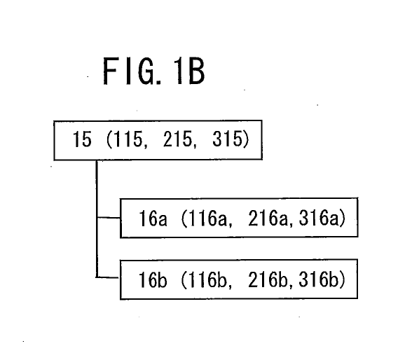

A driving tool 1 according to a first embodiment of the invention will be described while referring to FIGS. 1A through 5. As shown in FIG. 1A, a driving tool 1 is specifically a driving tool for driving a screw, and includes a housing 10, a motor 30, and a weight 40. A “screw” driven by the driving tool is a bolt meshing with a nut, for example, and means a fastener that requires little load for rotation at the start of driving and a rapidly increasing load at the completion of driving.

The housing 10 is constructed by a body housing section 11 and a handle housing section 12. The body housing section 11 and the handle housing section 12 are formed of resin as an integral part and connected integrally with each other. The body housing section 11 has substantially a cylindrical shape. The motor 30 and the weight 40 are aligned within the body housing section 11. In the following descriptions, the side at which the weight 40 is arranged relative to the motor 30 is defined as the front side, whereas the side at which the motor 30 is arranged relative to the weight 40 is defined as the rear side. In addition, the upper and lower directions are defined such that the lower direction is defined as a direction perpendicular to the front-rear direction and in which the handle housing section 12 extends from the body housing section 11.

A control circuit 15 and a storage device (not shown) are accommodated within the handle housing section 12. A trigger 13 is provided at an upper end part of the handle housing section 12. The storage device (not shown) preliminarily stores an upper limit value of electric current flowing through the motor 30 when a screw is seated on a workpiece. A rechargeable battery 14 is provided at a lower end part of the handle housing section 12 so as to be detachable from the handle housing section 12. The battery 14 is capable of supplying the motor 30 and the control circuit 15 with electric power. The control circuit 15 is configured to supply the motor 30 with electric power when the trigger 13 is operated by an operator.

Further, as shown in FIG. 1B, an operating section 16 is provided outside the body housing section 11 for setting a rotational speed of the motor 30, an electric current value flowing through the motor 30, and the like. The operating section 16 is electrically connected with the control circuit 15. The operating section 16 is provided with a motor reversing switch 16a to be described later. A switch 16b for switching the rotational direction of the motor 30 is arranged at a position of the body housing section 11 adjacent to the trigger 13.

The motor reversing switch 16b is a switch for rotating the motor 30 a predetermined angle in the opposite direction from the rotational direction set by the switch. In other words, if the motor 30 is set by the switch to rotate in the clockwise direction, by operating the motor reversing switch 16b, the motor 30 is rotated a predetermined angle in the counterclockwise direction.

An inner cover 36 is provided within the body housing section 11 at a part accommodating the weight 40 to be described later. A metal bearing 37 is provided at the rear side of the inner cover 36. The metal bearing 37 rotatably supports a rear end part of the weight 40 described later. The inner cover 36 is connected with a hammer case 38, such that the inner cover 36 and the hammer case 38 define a space accommodating the weight 40.

A seal member (not shown) is provided at a portion where the inner cover 36 overlaps the hammer case 38 in the upper-lower direction, such that the seal member is sandwiched between the inner cover 36 and the hammer case 38. The seal member (not shown) performs sealing so that internal lubricant does not leak out. A metal bearing 39 is provided on the inner circumferential surface of the front section of the hammer case 38, so as to rotatably support the front section of the weight 40.

The motor 30 is a brushless motor and is provided with an electric-current detecting device (not shown) that is capable of detecting electric current flowing through the motor 30. The electric-current detecting device (not shown) is electrically connected with the control circuit 15, so as to detect an electric current value in the control circuit 15. The motor 30 includes an output shaft 31 extending in the front-rear direction. The output shaft 31 is supported by the body housing section 11 via a bearing 32, so as to be rotatable relative to the body housing section 11. The output shaft 31 of the motor 30 is capable of rotating at 500 rad/s at a maximum. A fan 33 is provided at a part of the output shaft 31 located at the front side of the motor 30. The fan 33 is fixed to the output shaft 31 so as to be rotatable coaxially together with the output shaft 31. Mass of the fan 33 is 120 grams.

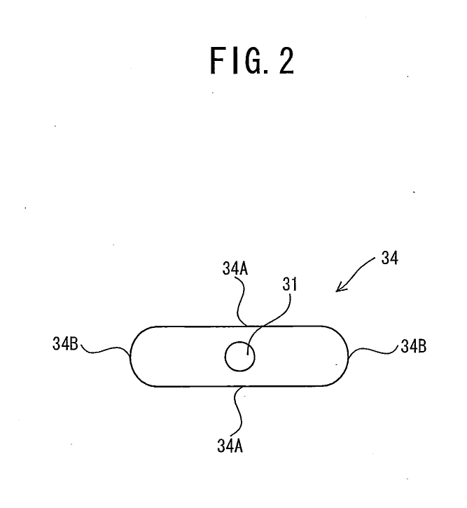

A weight engaging section 34 is provided at the front end part of the output shaft 31. As shown in FIG. 2, the weight engaging section 34 has a shape, in a front view, having a pair of sides 34A parallel with each other and a pair of arcs 34B connecting the respective ends of the pair of sides 34A. The output shaft 31 is fixed to the center position of the weight engaging section 34.

As shown in FIG. 1, the weight 40 is disposed within an internal front-side space of the body housing section 11. An engaging concave section 40a is formed at the rear end section of the weight 40. The engaging concave section 40a has substantially the same shape as the weight engaging section 34, such that the weight engaging section 34 engages the engaging concave section 40a. A front end section 40A of the weight 40 serves as a tool driving section and has substantially a cylindrical shape of which the rear side is closed. The front end section 40A of the weight 40 is exposed to outside of the body housing section 11 through the front end of the body housing section 11, and protrudes forward from the body housing section 11.

A sleeve 41 having substantially a cylindrical shape is provided at the front end section 40A of the weight 40, so as to be fitted over the front end section 40A of the weight 40. A convex section 41A protruding inward in the radial direction of the sleeve 41 is provided on the inner circumferential surface of the sleeve 41, such that the sleeve 41 is movable within a predetermined range in the front-rear direction. Further, an internal space of the front end section 40A of the weight 40 serves as an end-bit engaging concave section 40b that is capable of engaging the rear end section of an end bit (not shown) such as a hexagonal socket, the internal space having substantially a cylindrical shape.

A plurality of ball holding holes 40c is formed at the front end section 40A of the weight 40 so as to allow communication between the external space and the internal space of the front end section 40A. One ball 42 is disposed within each of the plurality of ball holding holes 40c. The ball 42 is movable outward in the radial direction of the front end section 40A of the weight 40, in a state where the ball 42 is not in contact with the convex section 41A of the sleeve 41 due to movement of the sleeve 41 in the front-rear direction. In this state, the rear end section of the end bit (not shown) is inserted into the end-bit engaging concave section 40b, such that the ball 42 engages a concave section (not shown) formed in the rear end section. Then, the sleeve 41 is moved so that the ball 42 is in contact with the convex section 41A of the sleeve 41. In this state, the ball 42 is restricted from moving outward in the radial direction of the front end section 40A of the weight 40, and the end bit (not shown) is connected with the front end section 40A so that the end bit is not detached from the front end section 40A of the weight 40. The front end section of the end bit (not shown) is formed with a hexagonal concave section having substantially the same shape as a head of a screw. Thus, the screw can be driven by driving the motor 30 to rotate the end bit in a state where the head of the screw is engaged in the concave section. The front end section 40A serves as an end-bit holding section.

Mass of the weight 40 is approximately 330 grams. Driving torque for driving a screw or the like by an end bit (not shown) changes depending on rotational energy of the end bit. A large amount of energy is required to obtain large driving torque. The relationship between the torque and the rotational energy changes depending on a size of a screw to be driven, rigidity at the time the screw is seated to a workpiece, resistance during rotation of the screw, and the like. In the driving tool 1, the rotational energy transmitted to an end bit per driving torque of 1 Nm is set to 0.2 to 0.4 J. The rotational energy per 1 Nm in a conventional oil-pulse tool is 0.1 J or less, and the rotational energy per 1 Nm in a conventional impact tool is approximately 0.02 J. Accordingly, the rotational energy, that is, the rotational speed and the moment of inertia in the driving tool 1 of the first embodiment is much larger than that of the conventional impact tool and oil-pulse tool.

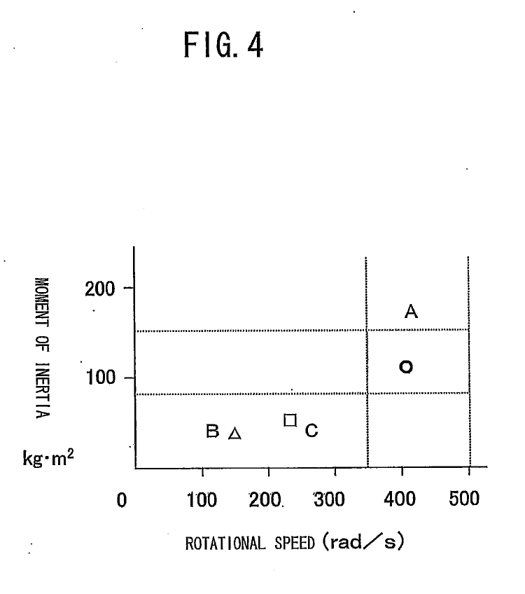

In the graph of FIG. 4, a symbol A denotes a relationship between the rotational speed of the motor 30 and the weight 40 and the moment of inertia of the weight 40 in the driving tool 1 of the first embodiment. Further, a symbol B denotes a relationship between the rotational speed of a hammer and the moment of inertia of the hammer in the conventional impact tool. Further, a symbol C denotes a relationship between the rotational speed of a driving section rotating in synchronization with the motor 30 and the moment of inertia of the driving section in the conventional oil-pulse tool. The graph of FIG. 4 shows that the driving tool 1 performs screw driving by rotating a large moment of inertia at a high rotational speed.

A value of driving torque is determined to some extent by a value of rotational energy. However, not only the value of the rotational energy but also a value of rotational speed and a value of moment of inertia suitable for the size of the motor 30 have to be determined For example, when driving torque of approximately 30 Nm is targeted, the rotational speed and the moment of inertia of the weight 40 are 350 rad/s to 500 rad/s and 80 kg·m² to 150 kg·m², respectively, in the present embodiment. More preferably, the rotational speed and the moment of inertia of the weight 40 are 400 rad/s and 100 kg·m², respectively.

If the weight 40 is too heavy, it takes time to reach a targeted rotational speed at a startup. Hence, the upper limit of the moment of inertia of the weight is 150 kg·m², and the lower limit of the rotational speed is 500 rad/s. Additionally, if the weight 40 is too light, the rotational speed of the motor 30 need to be increased, and an increase in mechanical loss of the fan 33 and the like lowers efficiency and also lowers torque of the motor 30, and hence the performance cannot be provided sufficiently. Hence, the lower limit of the moment of inertia of the weight is 80 kg·m², and the lower limit of the rotational speed is 350 rad/s. By using these values, the rotational energy of the end bit (not shown) can be set to 8 J to 16 J, so that the performance of screw driving can be obtained efficiently with the configuration of the driving tool 1 in the first embodiment.

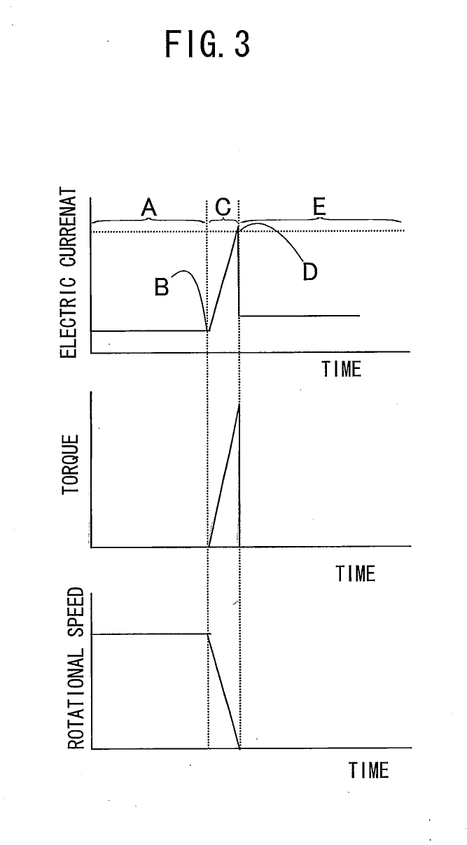

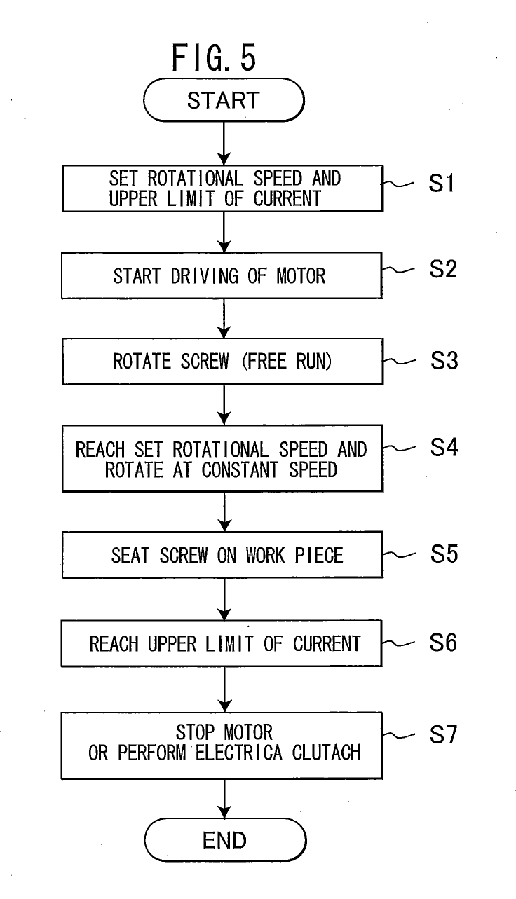

FIG. 5 shows controls by the control circuit 15 and operations of the driving tool 1 during driving a screw by the driving tool 1. First, a rotational speed of the motor 30 and an upper limit of electric current flowing through the motor 30 are inputted and set with an operating section 16 (S1). Next, the operator operates the trigger 13 to start driving of the motor 30 (S2). When driving of the motor 30 is started, a screw is rotated in a free-run state in which there is little resistance against driving a screw when the screw is rotated, and the rotational speed rises (S3). Then, once the motor 30 reaches the rotational speed set in S1, the motor 30 continues rotating at a constant rotational speed until the screw is seated on the workpiece as described below (S4, a section A in FIG. 3).

Next, when the screw is seated on the workpiece and stops rotation (S5, a point B in FIG. 3), an electric current value detected by the electric-current detecting device (not shown) rises rapidly, torque rises rapidly, and the rotational speed drops rapidly (S6, a section C in FIG. 3). Then, when the electric current value greater than or equal to the upper limit of electric current stored in a storage device (not shown) (S6, a point D in FIG. 3), supply of electric current to the motor 30 is stopped by the control circuit 15, or an electronic clutch is performed by the control circuit 15 (S7). Here, the electronic clutch is an operation of supplying the motor 30 with a low electric current with controls by the control circuit 15 so that rotation of the motor 30 is switched in the forward and reverse directions in a short cycle.

In the first embodiment, because the weight 40 having a large moment of inertia is rotated at a high speed, it is difficult to control driving torque. Further, when resistance rises before the screw is seated on the workpiece due to a dimension error between the screw and the hole or due to a foreign matter stuck between the screw and the hole, it is expected that a necessary rotational speed cannot be obtained and the performance of screw driving deteriorates. Additionally, if the workpiece to which a screw or the like is driven has low rigidity, the rotational energy is low when the screw is seated on the workpiece.

However, because the controls are performed by the control circuit 15 as shown in the above-described flowchart, some difference in resistance at the time of screw driving can be adjusted. Further, if electric current supplied to the motor 30 at the time of seating of the screw greater than or equal to the upper limit, supply of electric power is interrupted or decreased (electronic clutch), thereby cutting off extra rotational energy.

The driving tool 1 is provided with the weight 40 that is connected with the output shaft 31 of the motor 30 and that is capable of rotating coaxially together with the output shaft 31. Hence, at the time of seating when driving of a screw is completed by rotation of the end bit, only one strike can be performed in the rotational direction.

Thus, because impacts are not generated within the driving tool 1, striking noises are low and also reaction transmitted to the operator's hand can be suppressed. Further, torque can be controlled by adjusting the rotational speed with electrical controls. In addition, because a rotation reduction mechanism is not provided between the weight 40 and the output shaft 31 of the motor 30, reaction transmitted to the operator's hand can be further suppressed.

Further, the rotational energy of the tool per driving torque of 1 Nm is greater than or equal to 0.2 J and less than or equal to 0.4 J. Thus, the rotational speed of the motor 30 and the end bit can be easily set depending on a targeted driving torque based on these values.

Further, the moment of inertia of the weight 40 is 80 kg·m² to 150 kg·m². The motor 30 is capable of rotating the tool at a rotational speed of 350 rad/s to 500 rad/s. The rotational energy of the tool is greater than or equal to 8 J and less than or equal to 16 J. Thus, although the driving tool 1 generates low noises and low reaction, driving with large torque can be performed efficiently.

Further, because the weight 40 is directly connected with and fixed to the output shaft 31 of the motor 30, the configuration of the weight 40 rotating together with the output shaft 31 of the motor 30 can be simplified.

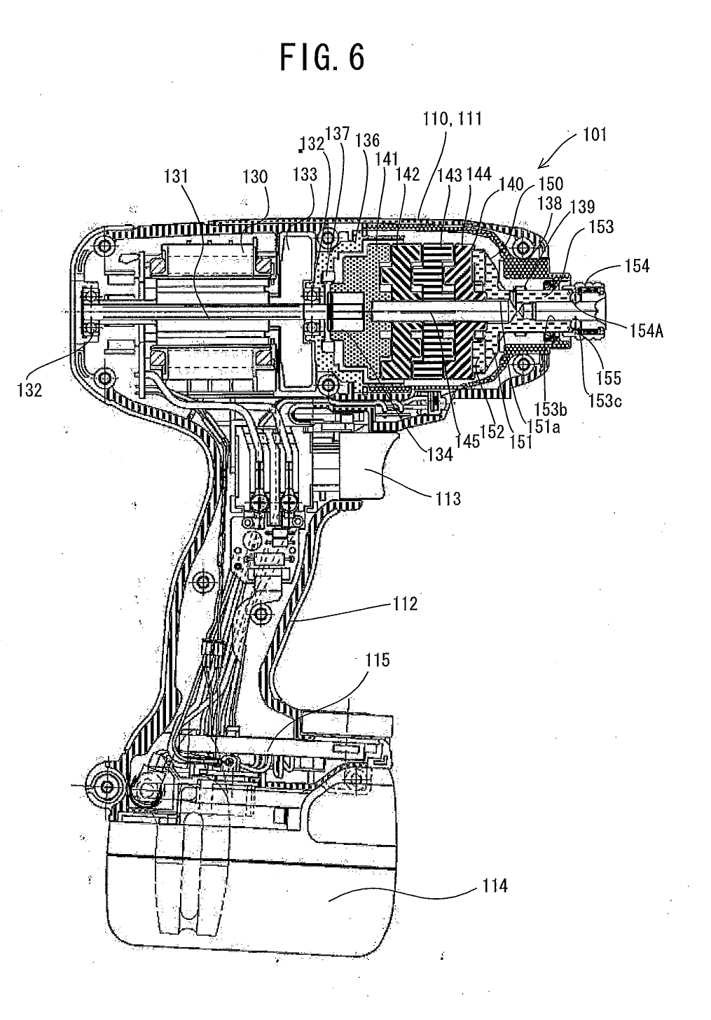

Next, a second embodiment of the invention will be described while referring to FIGS. 6 through 13. In the second embodiment, a weight 140 and an anvil 150 correspond to the weight 40 in the first embodiment, and the other configuration is the same as the driving tool 1 in the first embodiment. Thus, to each element of the second embodiment, the same reference number has been applied as the like element in the first embodiment, augmented by 100.

The weight 140 is disposed within a space defined by an inner cover 136 and a hammer case 138, and mainly includes four rotating bodies of a first rotating body 141 through a fourth rotating body 144 and a spindle 145. The four rotating bodies of the first rotating body 141 through the fourth rotating body 144 have disc shapes of the same diameter, and is arranged coaxially from the rear to the front such that the first rotating body 141 is located at the rearmost position and the fourth rotating body 144 is located at the foremost position, that the axial direction of each disc matches the front-rear direction, and that the discs are parallel with each other. Further, the first rotating body 141 through the fourth rotating body 144 are arranged such that each rotating body is rotatable.

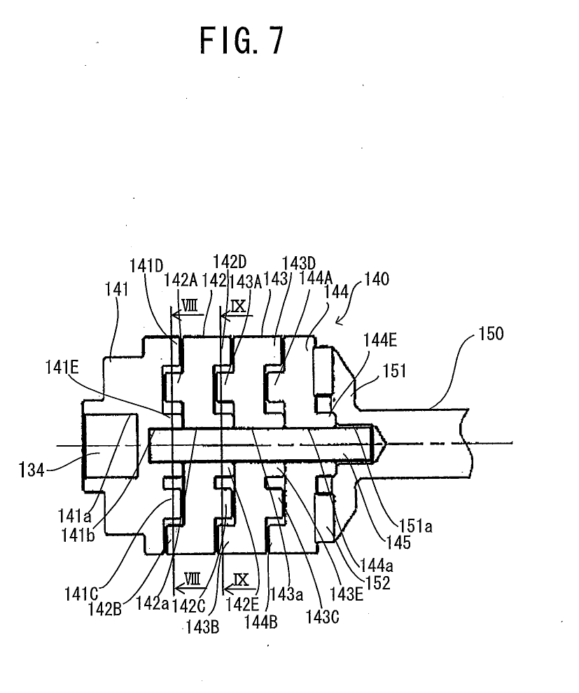

A metal bearing 137 is fitted over the outer circumference of the first rotating body 141, such that the first rotating body 141 is rotatably supported by the metal bearing 137. As shown in FIGS. 6 and 7, an engaging concave section 141a is formed at the rear surface of the first rotating body 141. The engaging concave section 141a has the same shape as a weight engaging section 134, and the weight engaging section 134 is coaxially fitted in the engaging concave section 141a.

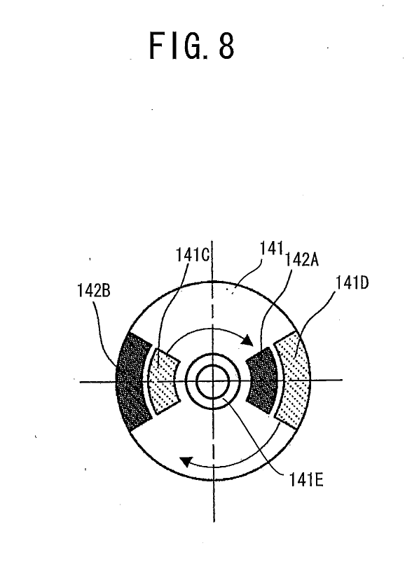

As shown in FIG. 8, a front inner-circumferential-side convex section 141C and a front outer-circumferential-side convex section 141D are provided on the front surface of the first rotating body 141. The front inner-circumferential-side convex section 141C and the front outer-circumferential-side convex section 141D protrude toward a second rotating body 142 side and serve as abutting sections that are capable of abutting the second rotating body 142. On a plane perpendicular to the front-rear direction, each of the front inner-circumferential-side convex section 141C and the front outer-circumferential-side convex section 141D is formed substantially in a fan shape having the same center angle of 60°. Further, the front inner-circumferential-side convex section 141C and the front outer-circumferential-side convex section 141D are arranged at positions shifted by 180° about the axial center of the first rotating body 141, and a distance between the axial center of the first rotating body 141 and the front inner-circumferential-side convex section 141C is different from a distance between the axial center of the first rotating body and the front outer-circumferential-side convex section 141D such that the respective trajectories of rotation about the axial center do not overlap each other. Further, both side surfaces of the front inner-circumferential-side convex section 141C and the front outer-circumferential-side convex section 141D in the circumferential direction are configured to be planes perpendicular to tangential direction about the axial center of the first rotating body 141 and to coincide with planes including the axial center of the first rotating body 141 and extending in the radial direction.

A protruding section 141E is provided at the axial center position on the front surface of the first rotating body 141 so as to protrude further forward than the front inner-circumferential-side convex section 141C and the front outer-circumferential-side convex section 141D. A boring hole 141b (FIG. 7) is formed at the protruding section 141E so as to be located on the axial center and to be open on the front surface of the protruding section 141E.

The second rotating body 142 through the fourth rotating body 144 have the same shape and are oriented in the same direction. Thus, the second rotating body 142 will be described as an example. As shown in FIGS. 7 and 8, the protruding section 141E of the first rotating body 141 abuts the rear surface of the second rotating body 142, so that the position of the second rotating body 142 in the front-rear direction is restricted relative to the first rotating body 141. A rear inner-circumferential-side convex section 142A and a rear outer-circumferential-side convex section 142B are provided on the rear surface of the second rotating body 142. The rear inner-circumferential-side convex section 142A and the rear outer-circumferential-side convex section 142B protrude toward the first rotating body 141 side and serve as abutting sections that are capable of abutting the front inner-circumferential-side convex section 141C and the front outer-circumferential-side convex section 141D of the first rotating body 141, respectively.

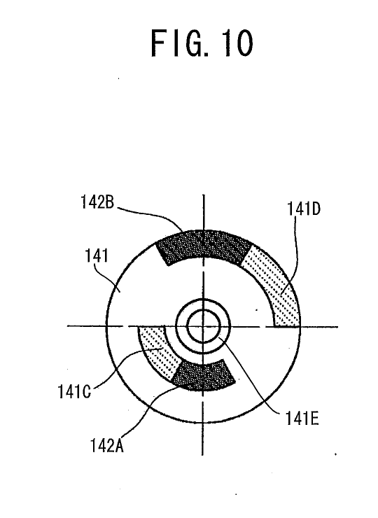

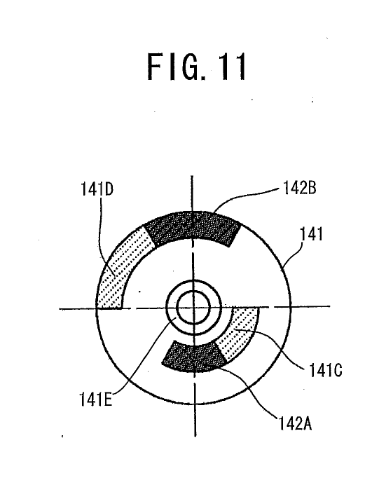

Each of the rear inner-circumferential-side convex section 142A and the rear outer-circumferential-side convex section 142B is formed substantially in a fan shape having the same center angle of 60°. Further, the rear inner-circumferential-side convex section 142A and the rear outer-circumferential-side convex section 142B are arranged at positions shifted by 180° about the axial center of the second rotating body 142, and a distance between the axial center of the second rotating body 142 and the rear inner-circumferential-side convex section 142A is different from a distance between the axial center and the rear outer-circumferential-side convex section 142B such that the respective trajectories of rotation about the axial center do not overlap each other. Further, one and the other side surfaces of each of the rear inner-circumferential-side convex section 142A and the rear outer-circumferential-side convex section 142B are configured to be planes perpendicular to the tangential direction and to coincide with planes including the axial center of the second rotating body 142 and extending in the radial direction. Further, the distance from the axial center to the rear inner-circumferential-side convex section 142A is equal to the distance from the axial center of the first rotating body 141 to the front inner-circumferential-side convex section 141C. Also, the distance from the axial center to the rear outer-circumferential-side convex section 142B is equal to the distance from the axial center of the first rotating body 141 to the front outer-circumferential-side convex section 141D. That is, the rear inner-circumferential-side convex section 142A and the rear outer-circumferential-side convex section 142B have the same shape as the front inner-circumferential-side convex section 141C and the front outer-circumferential-side convex section 141D, respectively. As described above, the first rotating body 141 and the second rotating body 142 are coaxially arranged to be rotatable. Hence, the first rotating body 141 and the second rotating body 142 can rotate from a state in which one side surfaces of the rear inner-circumferential-side convex section 142A and the rear outer-circumferential-side convex section 142B of the second rotating body 142 are in contact with the other side surfaces of the front inner-circumferential-side convex section 141C and the front outer-circumferential-side convex section 141D of the first rotating body 141 (FIG. 10) to a state in which the other side surfaces of the rear inner-circumferential-side convex section 142A and the rear outer-circumferential-side convex section 142B of the second rotating body 142 in the circumferential direction are in contact with the one side surfaces of the front inner-circumferential-side convex section 141C and the front outer-circumferential-side convex section 141D of the first rotating body 141 (FIG. 11). In other words, the second rotating body 142 can rotate 240° (240°=360°-60°×2), which is an angle less than 360° and in the neighborhood of 360°, relative to the first rotating body 141.

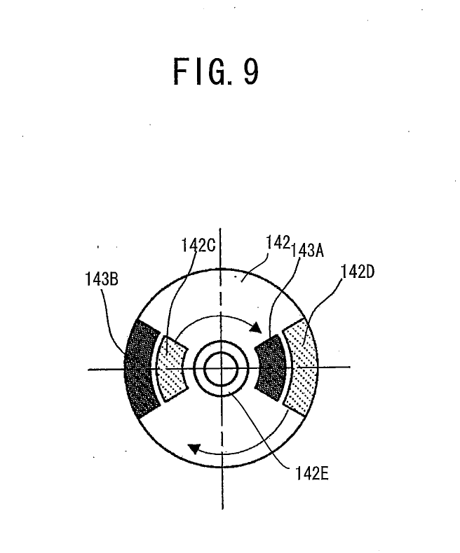

As shown in FIGS. 7 and 9, a front inner-circumferential-side convex section 142C and a front outer-circumferential-side convex section 142D are provided on the front surface of the second rotating body 142. The front inner-circumferential-side convex section 142C and the front outer-circumferential-side convex section 142D protrude toward a third rotating body 143 side and serve as abutting sections that are capable of abutting the third rotating body 143. The front inner-circumferential-side convex section 142C and the front outer-circumferential-side convex section 142D have the same shape as the front inner-circumferential-side convex section 141C and the front outer-circumferential-side convex section 141D of the first rotating body 141, respectively, and are arranged at positions shifted 180° about the axial center from the rear inner-circumferential-side convex section 142A and the rear outer-circumferential-side convex section 142B. Because the rear inner-circumferential-side convex section 142A and the rear outer-circumferential-side convex section 142B are shifted 180° from the front inner-circumferential-side convex section 142C and the front outer-circumferential-side convex section 142D, the position of the center of gravity of the second rotating body 142 can be aligned with the axial center position.

Further, a protruding section 142E is provided on the front surface of the second rotating body 142. The protruding section 142E is disposed at the axial center position and protrudes forward from the front inner-circumferential-side convex section 142C and the front outer-circumferential-side convex section 142D. The protruding section 142E abuts the third rotating body 143, thereby defining the distance between the second rotating body 142 and the third rotating body 143 in the front-rear direction. A through hole 142a (FIG. 7) is formed in the protruding section 142E so as to be located on the axial center and to each of the front surface of the protruding section 142E and the rear surface of the second rotating body 142. The through hole 142a is formed such that its inner diameter is the same as the inner diameter of the boring hole 141b.

The third rotating body 143 and the fourth rotating body 144 have the same shape as the second rotating body 142. Hence, the second rotating body 142 is rotatable 240° relative to the third rotating body 143, and the third rotating body 143 is rotatable 240° relative to the fourth rotating body 144. Thus, the first rotating body 141 is rotatable 240°×x3=720° relative to the fourth rotating body 144, and the second rotating body 142 is rotatable 240°×2=480° relative to the fourth rotating body 144.

The spindle 145 is a round bar of which the outer diameter is slightly smaller than the inner diameter of the boring hole 141b. As shown in FIG. 7, the spindle 145 penetrates through the boring hole 141b, the through hole 142a, a through hole 143a, and a though hole 144a, such that the front end protrudes from the front surface of a protruding section 144E of the fourth rotating body 144. The spindle 145 penetrates through the boring hole 141b through the though hole 144a, thereby suppressing deviation of the axial center among the first rotating body 141 through the fourth rotating body 144.

As shown in FIG. 6, the anvil 150 is constructed by a connecting section 151 having a cone shape of which the front side is truncated, and a front end section 153 connected with the front end of the connecting section 151. A pair of concave sections 152 and 152 protruding toward the fourth rotating body 144 is provided on the rear surface of the connecting section 151. The pair of concave sections 152 and 152 is arranged about the axial center of the anvil 150 at positions shifted 180° from each other, and is capable of abutting a front inner-circumferential-side convex section and a front outer-circumferential-side convex section of the fourth rotating body 144 (not shown). With the configurations of the pair of concave sections 152 and 152 and the front inner-circumferential-side convex section and the front outer-circumferential-side convex section (not shown), the fourth rotating body 144 is rotatable 120° relative to the anvil 150. Thus, the weight 140 is apparently rotatable 120° relative to the anvil 150.

As shown in FIG. 7, a boring hole 151a is formed at the axial center position of the rear surface of the connecting section 151 and is formed along the axial center. The boring hole 151a has an inner diameter similar to the boring hole 141b, and the front end of the spindle 145 is inserted into the boring hole 151a. The anvil 150 is supported by a metal bearing 139 (FIG. 6). Thus, the spindle 145 is also supported by the metal bearing 139 via the anvil 150.

As shown in FIG. 6, the front end section 153 is constructed as an integral body with the connecting section 151, and has a cylindrical shape of which the front end surface is formed with an opening and the rear side is closed. The front end section 153 is rotatably supported by the metal bearing 139. The front end section 153 is exposed to outside of the body housing section 111 through the front end of a body housing section 111, and protrudes further forward than the body housing section 111.

A sleeve 154 having a cylindrical shape is provided at the front end section 153, so as to be fitted over the front end section 153. The inner circumferential surface of the sleeve 154 is formed with a convex section 154A protruding inward in the radial direction of the sleeve 154, so that the sleeve 154 can move within a predetermined range in the front-rear direction. Further, an internal space of the front end section 153 serves as an end-bit engaging concave section 153b that is capable of engaging the rear end section of an end bit (not shown) such as a hexagonal socket, the internal space having a cylindrical shape.

A plurality of ball holding holes 153c is formed at the front end section 153 so as to allow communication between the external space and the internal space of the front end section 153. One ball 155 is disposed within each of the plurality of ball holding holes 153c. The ball 155 is movable outward in the radial direction of the front end section 153, in a state where the ball 155 is not in contact with the convex section 154A of the sleeve 154 due to movement of the sleeve 154 in the front-rear direction. In this state, the rear end section of the end bit (not shown) is inserted into the end-bit engaging concave section 153b, such that the ball 155 engages a concave section (not shown) formed in the rear end section. Then, the sleeve 154 is moved so that the ball 155 is in contact with the convex section 154A of the sleeve 154. In this state, the ball 155 is restricted from moving outward in the radial direction of the front end section 153, and the end bit (not shown) is connected with the front end section 153 so that the end bit is not detached from the front end section 153.

The front end section of the end bit (not shown) is formed with a hexagonal concave section having the same shape as a head of a bolt or the like. Thus, the bolt or the like can be driven by driving a motor 130 to rotate the end bit in a state where the head of the screw is engaged in the concave section. The front end section 153 serves as an end-bit holding section.

As described above, the weight 140 is divided into the four rotating bodies of the first rotating body 141 through the fourth rotating body 144. If respective masses of the first rotating body 141 through the fourth rotating body 144 are defined as m1 through m4 (m1+m2+m3+m4=M), the rotational energy of the weight 140 is generally given as ½Iω̂2. Here, I is moment of inertia, and w is angular velocity (rad/s). Assuming that the radius of the first rotating body 141 through the fourth rotating body 144 is r, the moment of inertia I is given as ½Mr̂2. Because each of m1 through m4 and r is a constant, the rotational energy depends on the angular velocity: ω.

The fourth rotating body 144 abutting the anvil 150 is rotatable with a rotational angle of 120° which is smaller than 360° relative to the anvil 150. As described above, however, the first rotating body 141 through the third rotating body 143 can rotate until rotational force is transmitted from the weight 140 to the anvil 150, that is, the fourth rotating body 144 rotates and the concave sections 152 and 152 of the anvil 150 abut the front inner-circumferential-side convex section and the front outer-circumferential-side convex section (not shown). Hence, rotational energy can be transmitted from the third rotating body 143 to the fourth rotating body 144, in a state sufficient rotational energy is accumulated where the motor 130 is driven with the weight 140 in a stopped state and then the first rotating body 141 and the subsequent rotating bodies rotate sequentially until the fourth rotating body 144 rotates and abuts the anvil 150. With this operation, the fourth rotating body 144 can abut the anvil 150 in a state where the angular velocity of the fourth rotating body 144 is increased. Note that, when the fourth rotating body 144 abuts the anvil 150, because the convex sections of neighboring ones of the first rotating body 141 through the fourth rotating body 144 abut each other, the first rotating body 141 through the fourth rotating body 144 rotate together, and thus the rotational energy accumulated at the first rotating body 141 through the fourth rotating body 144 is transmitted to the anvil 150. Accordingly, the first rotating body 141 through the fourth rotating body 144 abut the anvil 150 with angular velocity that is increased as a unit, thereby increasing striking force that is exerted on the anvil 150.

If the weight 140 did not have the above-mentioned divided structure, the weight 140 abuts the anvil 150 in a state where the weight 140 is only rotated 120° relative to the anvil 150 from a stopped state. In this case, the motor 130 rotates the weight 140 as a unit, the angular velocity of the weight 140 cannot be increased sufficiently in a state where the weight 140 is rotated 120° from the stopped state, due to inertial force of the weight 140. In contrast, with the divided structure of the weight 140 according to the second embodiment, although the weight 140 is apparently rotated only 120° relative to the anvil 150, each of the first rotating body 141 through the third rotating body 143 is rotated relative to the fourth rotating body 144. Hence, actually, at least the first rotating body 141 which is part of the weight 140 is rotated more than 360° relative to the anvil 150, and the weight 140 is rotated more than 360° relative to the anvil 150. Thus, compared with a weight having the same weight and outer diameter and having a non-divided structure, the rotational velocity at the time of abutting the anvil 150, that is, the rotational energy transmitted to the anvil 150 as striking force can be increased.

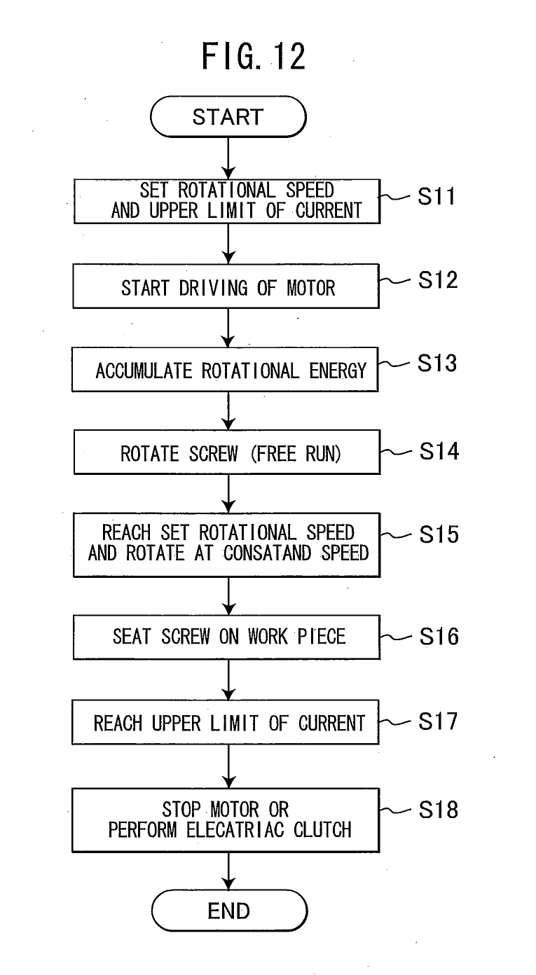

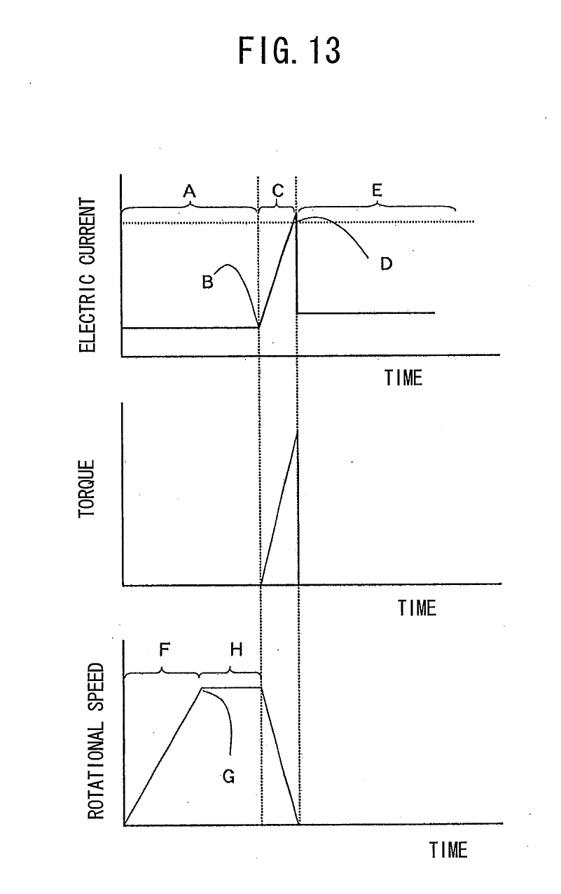

The flowchart shown in FIG. 12 and the timing chart shown in FIG. 13 show controls by the control circuit 115 and operations of a driving tool 101 when a screw is driven by the driving tool 101. First, the rotational speed of the motor 130 and an upper limit of electric current flowing through the motor 130 are inputted and set through an operating section 16 (S11). Next, the operator operates the trigger 113 to start driving of the motor 130 (S12). Once the motor 130 is started to be driven, rotational energy is preliminarily accumulated to the weight 140 in a state where the weight 140 can accumulate rotational energy (S13, a section F in FIG. 13).

The first rotating body 141 through the third rotating body 143 abut the neighboring rotating bodies, and the fourth rotating body 144 abuts the anvil 150, thereby causing the motor 130 and the anvil 150 to rotate together and also causing the screw held by the anvil 150. At this time, the screw rotates and the rotational speed increases in a free-run state in which there is little driving resistance of the screw (S14). Subsequently, when the motor 130 reaches the rotational speed set in S11, the motor 130 continues rotating at a constant rotational speed until the screw is seated on the workpiece, as will be described later (S15, a section H in FIG. 13).

Next, when the screw is seated on the workpiece and rotation of the screw is stopped (S 16, a point B in FIG. 13), an electric current value detected by an electric-current detecting device (not shown) rises rapidly, torque rises rapidly, and the rotational speed drops rapidly (S17, a section C in FIG. 13). Then, when the electric current value greater than or equal to the upper limit of electric current stored in a storage device (not shown) (S17, a point D in FIG. 13), supply of electric current to the motor 130 is stopped, or an electronic clutch is performed (S18). Here, the electronic clutch is an operation of supplying the motor 130 with a low electric current with controls by the control circuit 115 so that rotation of the motor 130 is switched in the forward and reverse directions in a short cycle.

In the present embodiment, because the weight 140 having a large moment of inertia is rotated at a high speed, it is difficult to control driving torque. Further, when resistance rises before the screw is seated on the workpiece due to a dimension error between the screw and the hole or due to a foreign matter stuck between the screw and the hole, it is expected that a necessary rotational speed cannot be obtained and the performance of screw driving deteriorates. Additionally, if the workpiece to which a screw or the like is driven has low rigidity, the rotational energy is low when the screw is seated on the workpiece.

However, because the controls are performed by the control circuit 115 as shown in the above-described flowchart, some difference in resistance at the time of screw driving can be adjusted. Further, if electric current supplied to the motor 130 at the time of seating of the screw greater than or equal to the upper limit, supply of electric power is interrupted or decreased (electronic clutch), thereby cutting off extra rotational energy.

The driving tool 1 is provided with the weight 140 that is connected with the output shaft 131 of the motor 130 and that is capable of rotating coaxially together with the output shaft 131. Hence, at the time of seating when driving of a screw is completed by rotation of the end bit, only one strike can be performed in the rotational direction.

Thus, because impacts are not generated within the driving tool 101, striking noises are low and also reaction transmitted to the operator's hand can be suppressed. Further, torque can be controlled by adjusting the rotational speed with electrical controls. In addition, because a rotation reduction mechanism is not provided between the weight 140 and the output shaft 131 of the motor 130, reaction transmitted to the operator's hand can be further suppressed.

The flowchart shown in FIG. 12 shows a process in which driving is performed during a normal operation where excessive torque is not required at a startup of the motor 130. On the other hand, excessive torque is required at a startup of the motor 130 during an additional tightening operation in which a screw is further tightened after the screw is driven once and during an operation in which a tightened screw is loosened. In these cases, the weight 140 preliminarily needs to accumulate rotational energy at a maximum. Specifically, by pressing a motor reversing switch 116b, the motor 130 is rotated a predetermined angle in the opposite direction (reverse direction) from the current rotational direction (forward direction) defined by a switch (not shown) (motor rotating means). Here, the “predetermined angle” is an angle with which the first rotating body 141 is rotated 240° in the forward direction relative to the second rotating body 142, the second rotating body 142 is rotated 240° in the forward direction relative to the third rotating body 143, the third rotating body 143 is rotated 240° in the forward direction relative to the fourth rotating body 144, and the fourth rotating body 144 is rotated 120° in the forward direction relative to the anvil 150 (240°×3+120°=840°), so that the weight 140 accumulates a maximum rotational energy.

By pulling the trigger 113 from this state to rotate the motor 130 in the forward direction, large striking force can be applied to the anvil 150, and an additional tightening operation and an operation to loosen a tightened screw can be performed appropriately. Further, striking noises that occur at this time are generated at a total of four times of abutments including an abutment between the first rotating body 141 and the second rotating body 142, an abutment between the second rotating body 142 and the third rotating body 143, an abutment between the third rotating body 143 and the fourth rotating body 144, and an abutment between the fourth rotating body 144 and the anvil 150. However, because these four times of abutments occur in an extremely short period, the operator recognizes these as a single striking noise, which contributes to low noise.

Further, the control in which the motor 130 is rotated the above-mentioned predetermined angle is not necessarily limited to pressing the motor reversing switch 16b. For example, a step for reversing the motor 130 the predetermined angle may be inserted between S11 and S12 in the flowchart shown in FIG. 12 (reversing means at motor rotation). This control enables a state in which the weight 140 is always capable of accumulating maximum rotational energy at a start of a driving operation. Further, a step for reversing the motor 130 the predetermined angle may be inserted subsequent to S18 in the flowchart shown in FIG. 12 (reversing means at motor stoppage). This control enables a state in which the weight 140 is always capable of accumulating maximum rotational energy when a next operation is performed after the motor 130 is stopped.

Further, the driving tool 101 includes a switch 116a for switching the rotational direction of the motor 130 (the rotational direction of an end bit). For example, when the forward direction of the motor 130 is switched to the counterclockwise direction with the switch 116a after the motor 130 is reversed the predetermined angle in order to be capable of accumulating rotational energy at the weight 140 in a state where the forward direction of the motor 130 is the clockwise direction, rotational energy cannot be accumulated even if the weight 140 is driven. Hence, if a signal from the switch (not shown) is inputted to the control circuit 115, the motor 130 is rotated the predetermined angle in the opposite direction from the forward direction in which the motor 130 rotates based on the signal inputted from the switch (reversing means at motor switching). This control enables a state in which the weight 140 is always capable of accumulating maximum rotational energy when the rotational speed of the motor 130 is switched to rotate the motor 130 in the forward direction.

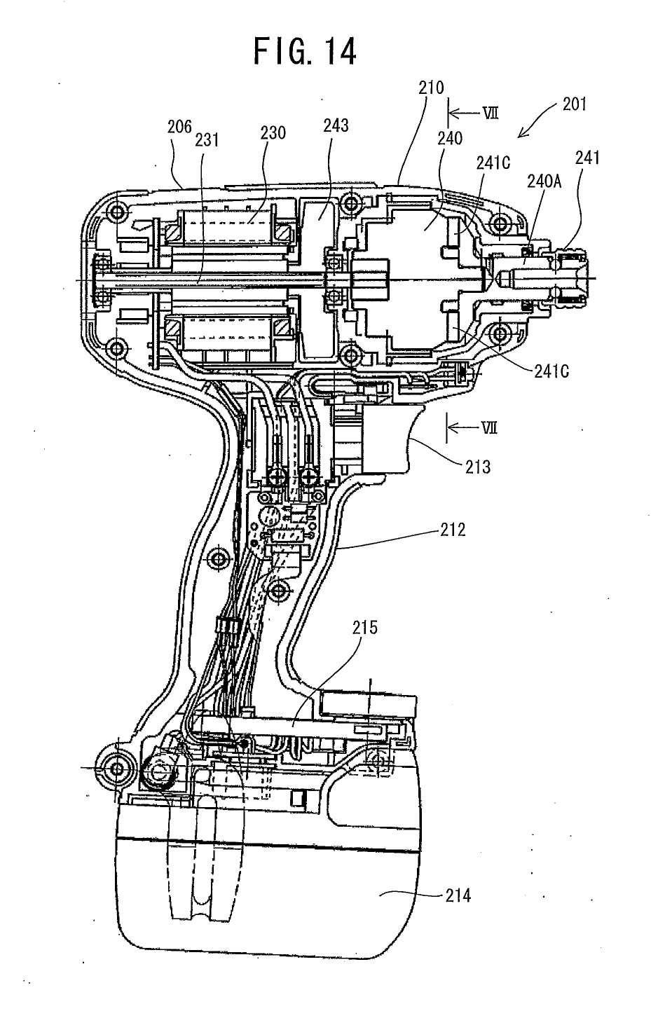

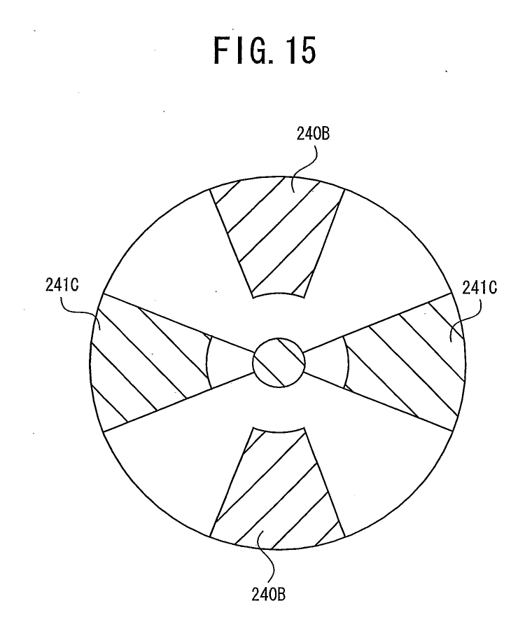

A driving tool of the invention is not limited to the above-described first embodiment and the second embodiment, but various changes and modifications may be made therein without departing from the scope of the claims. For example, although in the first embodiment an end bit (not shown) is detachably mounted to the end-bit driving section which is the front end section 40A of the weight 40, the configuration is not limited to this. For example, in a third embodiment shown in FIGS. 14 and 15, a weight 240 of a driving tool 201 and an anvil 240A struck by the weight 240 and serving as an end-bit driving section may be constructed by separate members and be rotated together as a unit. Note that, to each element of the third embodiment, the same reference number has been applied as the like element of the driving tool 1 in the first embodiment, augmented by 200.

Specifically, a pair of weight-side convex sections 241C protruding forward is provided on the front end surface of the weight 240 and is located symmetrically with respect to the axial center of the weight 240. As shown in FIG. 15, each of the weight-side convex sections 241C has a fan shape in cross-section along a plane perpendicular to the front-rear direction. A pair of fan-shaped mount-section-side convex sections 240B protruding rearward is provided on the rear end surface of the anvil 240A and is located symmetrically with respect to the axial center of the weight 240. Since the weight 240 rotates together with an output shaft 231 of a motor 230, the weight-side convex sections 241C rotatably move with the axial center of the weight 240 as the center, and abut the mount-section-side convex sections 240B, and press the mount-section-side convex sections 240B with the axial center of the weight 240 as the center, thereby coaxially rotating the anvil 240A together with the weight 240 and the output shaft 231 of the motor 230. The weight-side convex sections 241C and the mount-section-side convex sections 240B serve as rotation-start delaying means.

With this configuration, the anvil 240A has a free play for rotation of the weight 240, thereby adding a momentum of rotation to the weight 240 during a period after the weight 240 starts rotation and until the weight-side convex sections 241C abut the mount-section-side convex sections 240B. Hence, even if rotation stops before driving of a screw is completed with an end bit (not shown) due to some reason, without becoming a free-run state, the driving tool 201 can gets out such a stopped state and return to the free-run state. Further, a screw that is driven once can be further tightened.

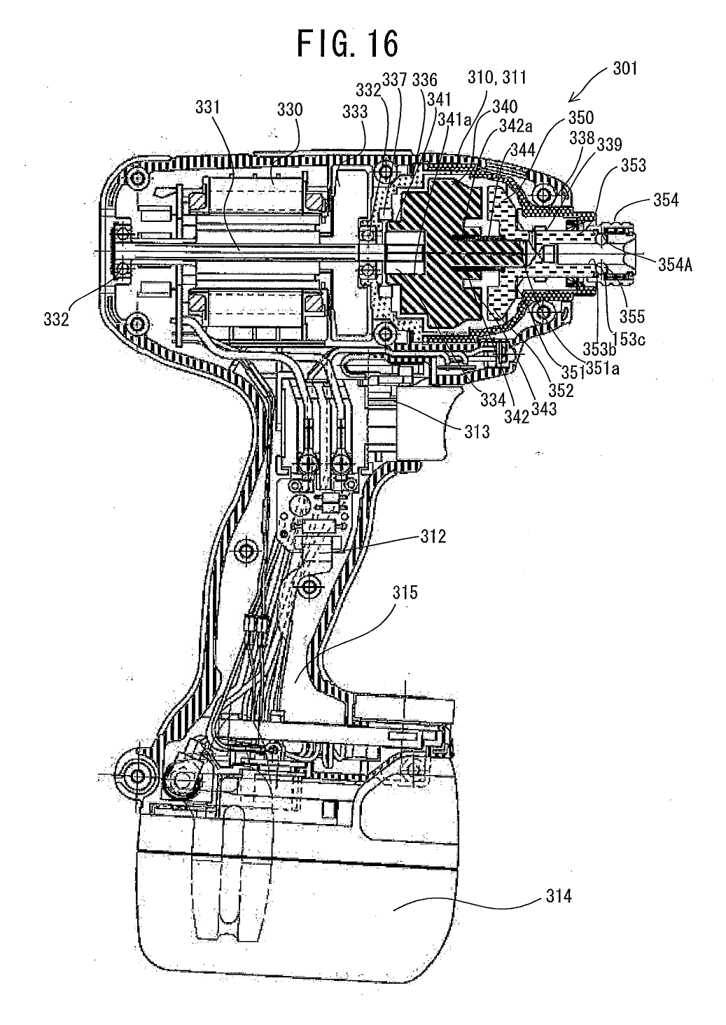

In the second embodiment, the weight 140 has a divided configuration for accumulating rotational energy. For example, however, in a fourth embodiment shown in FIG. 16, a weight 340 is configured to be a single cylindrical shape, and the weight 340 and an anvil 350 are connected with each other such that the weight 340 and an anvil 350 rotate together in a state the weight 340 rotates and rotational energy is accumulated to the weight 340. Note that, to each element of the fourth embodiment having the same configuration as the driving tool 1 of the first embodiment, the same reference number has been applied as the like element in the second embodiment, augmented by 200.

Specifically, the weight 340 is configured to have a single cylindrical shape of which the axial direction is the front-rear direction, and is disposed within a space formed by an inner cover 336 and a hammer case 338. A cylindrical-shaped rear-end-side protruding section 341 protruding from the rear surface of the weight 340 is provided on the axial center and on the rear surface of the weight 340. The weight 340 is rotatably supported by a metal bearing 337 at the outer circumference of the rear-end-side protruding section 341. Further, an engaging concave section 341a engaged by a weight engaging section 334 is formed on the axial center at the rear end position of the rear-end-side protruding section 341.

A cylindrical-shaped front-end-side protruding section 342 protruding from the front surface of the weight 340 toward the anvil 350 side is provide on the axial center on the front surface of the weight 340. The front-end-side protruding section 342 is inserted in a boring hole 351a described later and is rotatably supported. A series of grooves 342a surrounding the outer circumference of the front-end-side protruding section 342 is formed at a base position (rear side) of the front-end-side protruding section 342 on the front surface of the weight 340. Further, a pair of weight-side convex sections 343 and 343 protruding toward the anvil 350 is provided at the outer circumferential positions on the front surface of the weight 340. The pair of weight-side convex sections 343 and 343 is arranged at positions shifted 180° about the axial center from each other, and has a shape that is symmetrical about the axial center.

Further, a spring 344 is fitted around the front-end-side protruding section 342, is inserted in the grooves 342a, and is in contact with the anvil 350 to urge the anvil 350.

The anvil 350 is constructed by a connecting section 351 having a cone shape of which the front side is truncated, and a front end section 353 connected with the front end of the connecting section 351. The anvil 350 is configured to be rotatable relative to the hammer case 338 and is capable of sliding in the front-rear direction. A pair of convex sections 352 and 352 protruding toward the weight 340 is provided on the rear surface of the connecting section 351. The pair of convex sections 352 and 352 is arranged about the axial center of the anvil 350 at positions shifted 180° from each other. The pair of convex sections 352 and 352 is incapable of abutting the pair of weight-side convex sections 343 and 343 of the weight 340 in a state where the anvil 350 is moved to the forefront position, and is configured to abut the pair of weight-side convex sections 343 and 343 in the circumferential direction in a state where the anvil 350 is moved rearward.

The boring hole 351a extending along the axial direction is formed at the axial center position on the rear surface of the connecting section 351. The inner diameter of the boring hole 351a is slightly larger than the outer diameter of the front-end-side protruding section 342. The front end of the front-end-side protruding section 342 is inserted within the boring hole 351a, and the boring hole 351a has a boring depth that the anvil 350 can move in the front-rear direction relative to the weight 340 in a state where the front-end-side protruding section 342 is inserted in the boring hole 351a. The anvil 350 is supported by a metal bearing 339. Thus, the front-end-side protruding section 342 is also supported by the metal bearing 339 via the anvil 350.

As described above, the spring 344 is fitted around the front-end-side protruding section 342. Thus, because the front-end-side protruding section 342 is inserted in the boring hole 351a, the spring 344 is disposed between the weight 340 and the anvil 350, such that the spring 344 urges the anvil 350 forward relative to the weight 340. With this configuration, unless the anvil 350 moves rearward against urging force of the spring 344, rotational force is not transmitted from the weight 340 to the anvil 350.

The front end section 353 is constructed as an integral body with the connecting section 351, and has a cylindrical shape of which the front end surface is formed with an opening and the rear side is closed. The front end section 353 is supported by the metal bearing 339 such that the front end section 353 is rotatable and is capable of sliding in the front-rear direction.

In order to perform a driving operation with the above-described driving tool 301, after the driving tool 301 is pressed toward the screw side, that is, the front side in a state where a screw is engaged with the end bit (not shown), the operator pulls a trigger 313 to rotate a motor 330. By pressing the driving tool 301 toward the front side, the anvil 350 relatively moves rearward relative to the weight 340, that is, toward the weight 340 side, the pair of weight-side convex sections 343 and 343 and the pair of convex sections 352 and 352 can abut in the circumferential direction. When the motor 330 rotates in this state, the weight 340 also rotates and the pair of weight-side convex sections 343 and 343 abut the pair of convex sections 352 and 352, thereby transmitting rotational force to the anvil 350 and the end bit (not shown) to drive the screw.

Further, during an additional tightening operation in which a screw is further tightened after the screw is driven once and during an operation in which a tightened screw is loosened, the operator pulls the trigger 313 while the end bit is engaged with a screw before the driving tool 301 is pressed toward the front side, so that the weight 340 spins free in a state where the weight 340 does not abut the anvil 350. Then, when the driving tool 301 is pressed toward the front side in a state where rotational energy is accumulated at the weight 340, that is, in a state where angular velocity reaches the maximum velocity, the weight 340 and the anvil 350 are connected with each other, and rotational energy of the weight 340 is converted to striking force of the anvil 350.

With this configuration, rotational energy accumulated at the weight 340 can be the maximum, and the rotational energy in a high energy state can be converted to the striking force of the anvil 350. Additionally, because the pair of weight-side convex sections 343 and 343 abut the pair of convex sections 352 and 352 abut only once in the circumferential direction, striking noise can be reduced.

Although the front end section and the end bit are separate members in the first through fourth embodiment, these may be constructed as an integral member. Further, in the first embodiment, the weight 40 is fixed directly to the output shaft 31 of the motor 30, so that the weight 40 can rotate together with the output shaft 31 of the motor 30. However, the weight 40 need not be fixed directly to the output shaft 31 of the motor 30. Further, the number of the weight 40 is not limited to one. For example, a plurality of weights may be provided, a weight supporting section may be connected with the output shaft 31 of the motor 30, each of the plurality of weights may be fixed to the weight supporting section, and the plurality of weights may be capable of rotatably moving or rotating about the output shaft 31 of the motor 30.

Because the plurality of weights 140 is provided, a burden on a member supporting the weight 140, for example, the output shaft 131 of the motor 130 or the like can be distributed and reduced. Hence, damages of the output shaft 131 of the motor 130 can be suppressed. Further, slippage occurring between the output shaft 31 and the weight 140 can be suppressed, and an energy loss can be reduced.

Further, the weight is divided to accumulate rotational energy in the second embodiment, while the weight and the anvil are set to a cutoff state and a connection state to accumulate rotational energy in the fourth embodiment. Although these configurations are described in separate embodiments, these configurations may be combined. Specifically, if the anvil has the shape in the second embodiment, the weight has the shape in the first embodiment, and the front surface shape of the fourth rotating body is the front surface shape of the weight in the second embodiment, rotational energy can be accumulated by the weight, and the weight and the anvil can be set to the cutoff state and the connection state.

In the first through fourth embodiments, although the weight and the output shaft of the motor are connected directly and fixed with each other and rotate together, the configuration is not limited to this. For example, the weight and the output shaft of the motor may be coupled with each other and rotate together until a screw driving is completed after a screw is started to rotate, and subsequently coupling of the weight and the output shaft of the motor may be released to become a state in which the weight and the output shaft of the motor do not rotate together.

In the first through fourth embodiments, the rotational speed of the motor is controlled, and the electric current value supplied to the motor is changed depending on the electric current value flowing through the motor. However, only either one of the rotational speed and the electric current value may be controlled, not both of the rotational speed and the electric current value.

Although a brushless motor is used as a motor in the first through fourth embodiments, the motor is not limited to the brushless motor. For example, the motor may be an air motor.

Further, although the “screw” driven by the driving tool 1 in the above embodiments is specifically a bolt, the “screw” is not limited to a bolt. The “screw” only need to be one that requires little load for rotation at the start of driving and a rapidly increasing load at the completion of driving.

In the second embodiment, each rotating body can rotate 240° which is an angle adjacent to 360° and less than 360°, relative to a neighboring rotating body. However, this angle may be set to various values depending on various characteristics such as the material, the number, the size, etc. of the rotating bodies, as long as the angle is less than 360°.

1. A driving tool (1) comprising:
a motor (30) including an output shaft; and
an end-bit holding section (41) connected to and rotated by the motor and configured to hold an end-bit,
characterized in that the driving tool further comprises a weight (40) connected to the motor without a reduction mechanism and rotatable together with the motor and the end-bit holding section.

2. The driving tool according to claim 1, further comprising at least one of a first control unit (15: S4) and a second control unit (15:S7),
wherein the first control unit controls the motor to rotate at constant rotational speed, and
wherein the second control unit stops or reduces supply of electric current to the motor when a value of the electric current flowing through the motor is greater than or equal to a prescribed value.

3. The driving tool according to claim 1, wherein the motor and the weight are configured to transmit to the end-bit holding section a rotational energy per driving torque of 1 Nm in a range from 0.2 J to 0.4 J.

4. The driving tool according to claim 3 wherein the weight provides a moment of inertia in a range from 80 kg·m2 to 150 kg·m2,
wherein the motor is rotatable at a rotational speed in a range from 350 rad/s to 500 rad/s, and
wherein the motor and the weight transmits the rotational energy to the end-bit holding section in a range from 8 J to 16 J.

5. The driving tool according to claim 1, wherein the weight is directly fixed to the motor.

6. The driving tool according to claim 1, wherein the weight includes a plurality of weight segments.

7. The driving tool according to claim 1, further comprising a rotational start delaying unit (241C, 240B) through which the weight is connected to the end-bit holding section to rotate the weight together with the end-bit holding section after the weight rotates a prescribed angle from start of rotation.

8. A driving tool (1) comprising:
a motor (130); and
an end-bit holding section (150),
characterized in that:
the driving tool further comprises a weight (140) configured to accumulate rotational energy by being rotated by the motor;
the weight is connected to an end-bit through the end-bit holding section (150); and
the weight transmits a rotational energy after at least part of the weight rotates by equal to or greater than 360 degrees.

9. The driving tool according to claim 8, wherein the weight is directly fixed to the motor and is directly fixed to the end-bit holding section after at least part of the weight rotates by equal to or greater than 360 degrees.

10. The driving tool according to any one of claims 8 and 9, further comprising at least one of a first control unit (115: S15) and a second control unit (115: S18),
wherein the first control unit controls the motor to rotate at constant rotational speed, and
wherein the second control unit stops or reduces supply of electric current to the motor when a value of the electric current flowing through the motor is greater than or equal to a prescribed value.

11. The driving tool according to any one of claims 8 and 9, wherein the weight includes a plurality of weights coaxially rotatable about a rotational axis, the plurality of weights including a first weight located at a first position on the rotational axis and a second weight located at a second position on the rotational axis and different from the first position,
wherein the first weight is configured to be connected to the end-bit holding section, and the second weight is rotated by the motor,
wherein one weight of the plurality of weights contacts another weight of the plurality of weights that is adjacent to the one weight after the one weight rotates by approximately 360 degrees.

12. The driving tool according to claim 11, further comprising a control unit (115) and a switch (113),
wherein when the control unit receives a signal from the switch in a state where the motor is stopped, the control unit controls the motor to rotate such that the one weight contacts another weight after the one weight rotates approximately 360 degrees.

13. The driving tool according to claim 11, further comprising a control unit including (115) at least one of a first reversing unit and a second reversing unit,
wherein the first reversing unit controls the motor to rotate the second weight approximately in a first direction and subsequently to rotate the second weight in a second direction opposite to the first direction,
wherein after the motor rotates in the second direction, the second reversing unit controls the motor to rotate the second weight approximately 360 degrees in the first direction and subsequently stops the motor.

14. The driving tool according to claim 11, further comprising a control unit (115) and a reversing switch (116a) reversing rotational direction of the motor, thereby designating the rotational direction of the motor,
wherein after the control unit receives a signal instructing to reverse the rotational direction of the motor, the control unit controls the motor to rotate the second weight by approximately 360 degrees relative to a weight of the plurality of weights adjacent to the second weight in a direction opposite to the direction designated by the reversing switch.

15. The driving tool according to any one of claims 8-10, wherein the end-bit holding section rotates about a rotational axis and includes a holding-section-side contact part,
the driving tool further comprising a supporting section (344) rotatably supporting the end-bit section and slidably supporting the end-bit in a direction parallel to the rotational axis of the end-bit,
wherein the weight rotates coaxially with the end-bit holding section and includes a weight-side contact part,
wherein only when the end-bit holding section slides toward the weight, the holding-section-side contact part contacts the weight-side contact parts and the end-bit supporting section rotates coaxially with the weight.
